(19) United States
(12) Patent Application Publication
(10) Pub. No.: US 2013/0213508 A1
(43) Pub. Date: Aug. 22, 2013

(54) FILL MATERIAL DISPENSING METHOD AND APPARATUS

(71) Applicant: Shannon Keith Latimer, Barons (CA)

(72) Inventor: Shannon Keith Latimer, Barons (CA)

(21) Appl. No.: 13/743,734

(22) Filed: Jan. 17, 2013

(30) Foreign Application Priority Data
Feb. 16, 2012 (CA) 2768538

(51) Int. Cl. B65G 53/00

(52) U.S. Cl. CPC B65G 53/00
USPC 137/613

(57) ABSTRACT

The invention seeks to provide a method and apparatus for introducing fill material such as walnut shells at a desired volumetric flow rate into a fluid to be injected into a borehole. A valve is provided to enable adjustment of the volumetric flow rate as desired during introduction of the fill material.

### FIELD OF THE INVENTION

The present invention relates to the introduction of fill material for use in downhole applications in the oil and gas industry. Specifically, the present invention relates to methods and apparatuses for introducing such fill material in a controlled manner.

### BACKGROUND OF THE INVENTION

It is know in the oil and gas industry to pump fluids downhole for various reasons. For example, when drilling a borehole, a drilling crew injects drilling fluid or “mud” into the borehole to lift rock cuttings from the borehole bottom (thereby preventing them from settling in the bottom and potentially seizing the drill bit), to help stabilize and seal the borehole walls, and to cool, clean and lubricate the bit and drill pipe. In a further example, fluids are pumped downhole under substantial pressure to artificially fracture particular underground hydrocarbon-containing formations that are not producing sufficient hydrocarbon flow into the wellbore, often due to insufficient permeability or porosity in the target formation.

It is also known to enhance the utility of such injected fluids by the inclusion of various additives. In the example of drilling mud, additives are sometimes incorporated to help prevent fluid loss into an unconsolidated or highly porous and permeable formation through which the drill has passed, in which case additives such as crushed walnut shells are included in the drilling mud to block the flow paths and reduce the loss of mud into the region around the borehole. Where the drilling is directional or horizontal drilling, walnut shells can also provide some lubrication under the drill pipe, which aids in moving the pipe during slides. In the example of well fracturing, small particulate matter (sand, walnut shells, etc.) is included in the fracturing fluid as a proppant, which functions to hold open the newly-created fluid flow pathways created by the fracturing and thereby allows the more ready flow of hydrocarbon into the wellbore for pumping to the surface.

Additives are introduced into the fluid at the surface in a manual process involving one of the rig crew such as the derrick hand. In the case of crushed walnut shells for use with drilling mud, for example, the derrick hand will take a bag of shells and set it on the grate cover of the mud tank, and will then puncture the bottom of the bag to allow the shells to trickle down through the grate and into the mud supply. However, the derrick hand has other tasks to attend to on the platform and cannot monitor the bag. This sometimes results in oversize debris in the bag blocking off the release of shells. Another known problem is that the humidity rising from the mud tanks can cause the shells to stick together and plug off the hole in the bag. Getting a consistent flow of fill material can therefore be a significant challenge. In addition, where supply has been choked off for some reason, the derrick hand will overcompensate by adding a large amount of fill material, but this can result in plugging of certain tools such as MWD (measurement-while-drilling) tools which requires that the crew trip out the drill string and replace the tool, a costly step that also delays adding new lengths of pipe to continue the drilling operation. Even when a bag is delivering a flow of shells without any blockages, the supply is not consistent and the inability to continuously monitor the supply can result in the bag running empty, with the same problems as with a plugged bag.

What is needed, therefore, is an apparatus and method that can deliver the needed fill material at a desired rate for the particular application, in a consistent manner that does not require constant oversight by platform personnel.

### SUMMARY OF THE INVENTION

The present invention therefore seeks to provide an apparatus and method that can be employed to consistently introduce fill material at a user-established rate.

According to a first aspect of the present invention there is provided an apparatus for dispensing a fill material at a desired volumetric flow rate for use in a fluid to be injected into a borehole, the apparatus comprising:
a container for receiving the fill material, the container provided with egress means situate within a lower portion of the container;
a channelling member having upper and lower ends, the channelling member connected at the upper end to the egress means for receiving the fill material therefrom and directing the fill material away from the container; and
a valve connected to the lower end of the channelling member for receiving the fill material therefrom, the valve configured to allow variable adjustment of the volumetric flow rate of the fill material passing therethrough.

According to a second aspect of the present invention there is provided a method for dispensing a fill material at a desired volumetric flow rate for use in a fluid to be injected into a borehole, the method comprising:
a. providing an apparatus comprising:
   a container having egress means situate within a lower portion of the container;
   a channelling member having upper and lower ends, the channelling member connected at the upper end to the egress means; and
   a valve connected to the lower end of the channelling member, the valve configured to allow variable adjustment of the volumetric flow rate of the fill material passing therethrough;
b. positioning the apparatus adjacent a supply of the fluid such that the fill material will pass through the valve and into the supply of the fluid;
c. adjusting the valve to enable a desired volumetric flow rate:
d. filling the container with the fill material;
e. allowing the fill material to pass through the egress means into the channelling member;
f. allowing the fill material to pass through the channelling member and subsequently through the valve; and
g. allowing the fill material to enter the supply of the fluid.

In some exemplary embodiments of the apparatus according to the present invention, the apparatus further comprises a removable screening member situate within an upper portion of the container, and preferably a housing for receiving and supporting the container, the housing comprising an opening for allowing dispensation of the fill material from the valve to the exterior of the housing. The housing preferably comprises a removable cover for the housing. The fill material preferably comprises walnut shells, although other appropriate materials known to those skilled in the art could be substituted. The container preferably comprises a hopper having inwardly angled lower walls tapering toward the egress means, with the channelling member comprising a downwardly angled hollow conduit. While various valve types could be employed with the present invention, the valve is preferably a plastic ball valve.

In some exemplary embodiments of the method according to the present invention, a step is included after step d for allowing the removable screening member to screen oversized particles within the fill material, and in preferred embodiments the method would include the additional step of re-filling the container when the fill material becomes depleted. A further preferred additional step is to position the cover on the housing to prevent the ingress into the container of atmospheric precipitation, debris or other undesirable matter. In some methods it may be desired to change the flow rate due to changing conditions in the well, in which case a preferred method would include a further step after step c of re-adjusting the valve when an adjusted volumetric flow rate is desired. Where the operator wishes to start with the valve completely closed, the desired volumetric flow rate is zero in step c, the container is then filled with the fill material at step d, and the volumetric flow rate is subsequently adjusted to an adjusted volumetric flow rate that allows the fill material to enter the supply of the fluid. In exemplary embodiments, the fluid is either drilling mud and the fill material is used for lost circulation recovery or directional drilling pipe lubrication, or the fluid is fracturing fluid and the fill material is used as proppant in a formation fracturing process, but it would be clear to one skilled in the art that other applications are possible within the scope of the invention.

A detailed description of an exemplary embodiment of the present invention is given in the following. It is to be understood, however, that the invention is not to be construed as being limited to this embodiment.

### BRIEF DESCRIPTION OF THE DRAWINGS

In the accompanying drawings, which illustrate an exemplary embodiment of the present invention:

FIG. 1 is a cut-away side elevation view of an embodiment of the present invention;

FIG. 2 is a side elevation view of the embodiment of FIG. 1 without the housing and screen; and

FIG. 3 is a top plan view of the embodiment of FIG. 1 without the removable cover.

A preferred embodiment of the present invention will now be described with reference to the accompanying drawings.

### DETAILED DESCRIPTION OF EXEMPLARY EMBODIMENTS

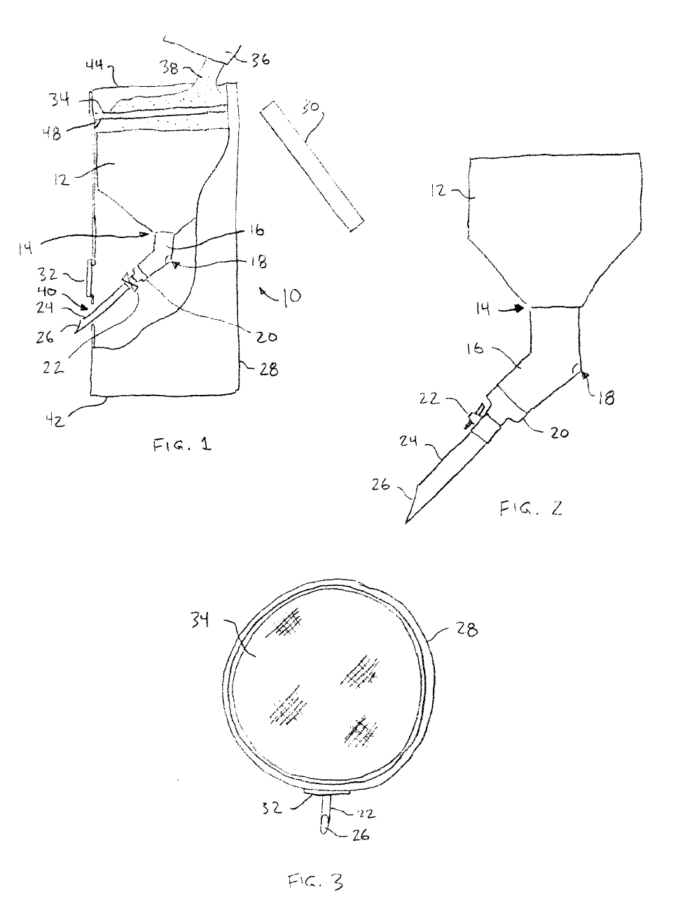

An apparatus 10 according to the present invention is illustrated in FIGS. 1 and 2. The apparatus 10 comprises a container or hopper 12 for receiving and temporarily storing the fill material 38. The container 12 can be made of any suitable material, but steel is the preferred material. As can be seen in the illustrated embodiment, the container 12 is preferably designed to have a cylindrical upper half and inwardly angled lower walls to help direct the downward flow of fill material 38. Upon reaching the bottom of the container 12, the fill material 38 reaches the egress means 14, a hole in the bottom of the container 12. Rather than passing straight down from the egress means 14, however, the fill material 38 is instead directed into a 2-inch diameter channelling member 16, which comprises a 45 degree elbow 18. The channelling member 16 is connected at its downstream end to a reducer 20 and subsequently to a valve 22. The reducer 20 is a 2 inch to 1 inch reducer, and the valve 22 is a 1 inch valve. Different valve types could be employed, with varying suitability depending on the nature of the fill material 38, but it has been found that for crushed walnut shells a plastic quarter turn ball valve is preferable. In other contexts or with other fill materials, a different valve (e.g. a gate valve, steel construction) could be used, as would be clear to one skilled in the art.

The valve 22 is connected at its downstream end to a 1 inch nipple 24 which extends a desired length away from the valve 22. In the embodiment illustrated in FIG. 1, the nipple 24 is of sufficient length to pass beyond the outer wall of the housing 28 through an opening 40. As indicated above, humidity rising off of mud tanks can present a problem when attempting to introduce walnut shells, and a downwardly facing egress means has been found to exacerbate the problem, so the nipple 24 is provided with an angled cut-off end 26 which helps to prevent some humidity access while still allowing fill material 38 to pass out of the nipple 24. As can be seen in FIGS. 2 and 3, the end 26 is cut so that the opening in the nipple 24 is upwardly disposed without blocking the dispensing of fill material 38.

In the exemplary embodiment, the container 12 and attached elements are situated in a housing 28, as can be seen in FIG. 1. The housing 28 is preferably a 30 gallon plastic barrel, with the container 12 configured to hold two standard bags of walnut shells. The housing 28 is provided with a flat base 42 to enable it to be positioned in a stable manner above the tank into which the fill material 38 is being dispensed. The housing 28 is also provided with a removable cover 30, again preferably composed of plastic, which can be positioned on the top rim 44 of the housing 28 once the container 12 has been provided with a desired amount of fill material 38. Further, the housing 28 is provided with a door 32 which provides access to the valve 22 for adjustment thereof; the door 32 can be of any known configuration, including a door slidable within guides between opened and closed positions, a door removably secured in place using screws or bolts, or any other known way of providing the necessary access.

As mentioned above, it is known that bags of fill material 38 can sometimes contain oversize debris which would otherwise block off the release of fill material 38. As the valve 22 and nipple 24 have a one-inch inner diameter, an operator will want to ensure that this is addressed to avoid plugging. The preferred embodiment therefore comprises a screen 34 configured to screen out material larger than a predetermined size. In the exemplary embodiment, the screen 34 is a ¼ inch perforated stainless steel screen. The screen 34 is housed within a circular screen rim 46 which is removable from the housing 28. The inner wall of the housing 28 is provided with screen rim supports 48 on which the screen rim 46 rests when installed within the housing 28. Other means of removably positioning the screen 34 above the container 12 would be clear to one skilled in the art, and the screen 34 could also be secured inside the housing 28 in a non-removable manner. It should be stressed that the present invention would work without a screen, but that it could plug off more often due to the inclusion of larger debris in fill material 38 bags which plugs off the valve 22.

In a preferred mode of operation, an operator would provide the apparatus 10 as described above and position it adjacent a supply of the target injection fluid such that the fill material 38 will pass through the valve 22 and into the supply of the fluid. The operator would then adjust the valve 22 to enable a desired volumetric flow rate of the fill material 38 passing through the valve 22. The operator would take a bag 36 of fill material 38, open it and empty it onto the screen 34, allowing the fill material 38 to pass through the screen 34 (screening out undesirably large material) and toward the egress means 14. The cover 30 would then preferably be positioned on the top rim 44 of the housing 28 to prevent the ingress into the container 12 of atmospheric precipitation, debris or other undesirable matter. The fill material 38 would subsequently pass through the channelling member 16, reducer 20, and valve 22, where the valve 22 would control the flow. The controlled flow would then pass into the nipple 24 and out at the cut-off end 26, proceeding downwardly toward the target fluid. The container 12 would be re-filled as necessary, as the fill material 38 supply became depleted.

In some methods it may be desired to change the flow rate due to changing conditions in the well, in which case a preferred method would include a further step of re-adjusting the valve 22 when an adjusted volumetric flow rate is desired. Where the operator wishes to start with the valve 22 completely closed, for example when preparing the supply of fill material 38 before it is actually required to be introduced to the injection fluid, the desired volumetric flow rate can be set at zero by closing off the valve 22 and the container 12 is then filled with the fill material 38, with the volumetric flow rate subsequently adjusted to an adjusted volumetric flow rate that allows the fill material 38 to enter the supply of the injection fluid. In exemplary embodiments, the fluid is either drilling mud and the fill material 38 is used for lost circulation recovery or directional drilling pipe lubrication, or the fluid is fracturing fluid and the fill material 38 is used as proppant in a formation fracturing process, but it would be clear to one skilled in the art that other applications are possible within the scope of the invention.

As can be readily seen, then, there are numerous advantages provided by the present invention. For example, The issue of feed consistency is addressed by enabling fill material introduction at a set rate which can be easily adjusted as conditions require. More than one bag of fill material can be prepared at a time, which again reduces the burden on rig personnel. Further, there is a reduced risk of plugging from both oversize materials and humidity penetration, and a reduced or even eliminated need for top-up fill material which can damage MWD tools.

The foregoing is considered as illustrative only of the principles of the invention. The scope of the claims should not be limited by the preferred embodiments set forth in the foregoing examples, but should be given the broadest interpretation consistent with the specification as a whole.

1. An apparatus for dispensing a fill material at a desired volumetric flow rate for use in a fluid to be injected into a borehole, the apparatus comprising:
a container for receiving the fill material, the container provided with egress means situate within a lower portion of the container;
a channelling member having upper and lower ends, the channelling member connected at the upper end to the egress means for receiving the fill material therefrom and directing the fill material away from the container; and
a valve connected to the lower end of the channelling member for receiving the fill material therefrom, the valve configured to allow variable adjustment of the volumetric flow rate of the fill material passing therethrough.

2. The apparatus of claim 1 further comprising a removable screening member situate within an upper portion of the container.

3. The apparatus of claim 1 further comprising a housing for receiving and supporting the container, the housing comprising an opening for allowing dispensation of the fill material from the valve to the exterior of the housing.

4. The apparatus of claim 3 further comprising a removable cover for the housing.

5. The apparatus of claim 1 wherein the fill material comprises walnut shells.

6. The apparatus of claim 1 wherein the container comprises a hopper having inwardly angled lower walls tapering toward the egress means.

7. The apparatus of claim 1 wherein the channelling member comprises a downwardly angled hollow conduit.

8. The apparatus of claim 1 wherein the valve is a plastic ball valve.

9. A method for dispensing a fill material at a desired volumetric flow rate for use in a fluid to be injected into a borehole, the method comprising:
a. providing an apparatus comprising:
a container having egress means situate within a lower portion of the container;
a channelling member having upper and lower ends, the channelling member connected at the upper end to the egress means; and
a valve connected to the lower end of the channelling member, the valve configured to allow variable adjustment of the volumetric flow rate of the fill material passing therethrough;
b. positioning the apparatus adjacent a supply of the fluid such that the fill material will pass through the valve and into the supply of the fluid;
c. adjusting the valve to enable a desired volumetric flow rate;
d. filling the container with the fill material;
e. allowing the fill material to pass through the egress means into the channelling member;
f. allowing the fill material to pass through the channelling member and subsequently through the valve; and
g. allowing the fill material to enter the supply of the fluid.

10. The method of claim 9 wherein the apparatus further comprises a removable screening member situate within an upper portion of the container, the method comprising the further step after step d of allowing the removable screening member to screen oversized particles within the fill material.

11. The method of claim 9 wherein the apparatus further comprises a housing for receiving and supporting the container, the housing comprising an opening for allowing the fill material to leave the housing and enter the supply of the fluid.

12. The method of claim 11 wherein the apparatus further comprises a removable cover for the housing, the method comprising the further step after step d of positioning the cover on the housing to prevent the ingress into the container of atmospheric precipitation, debris or other undesirable matter.

13. The method of claim 9 wherein the fill material comprises walnut shells.

14. The method of claim 9 wherein the container comprises a hopper having inwardly angled lower walls tapering toward the egress means.

15. The method of claim 9 wherein the channelling member comprises a downwardly angled hollow conduit.

16. The method of claim 9 wherein the valve is a plastic ball valve.

17. The method of claim 9 comprising the further step of re-filling the container when the fill material therein becomes depleted.

18. The method of claim 9 comprising the further step after step c of re-adjusting the valve when an adjusted volumetric flow rate is desired.

19. The method of claim 9 wherein the desired volumetric flow rate is zero in step c, the container is filled with the fill material at step d. and the volumetric flow rate is subsequently adjusted to an adjusted volumetric flow rate that allows the fill material to enter the supply of the fluid.

20. The method of claim 9 wherein the fluid is drilling mud and the fill material is used for lost circulation recovery or directional drilling pipe lubrication.

21. The method of claim 9 wherein the fluid is fracturing fluid and the fill material is used as proppant in a formation fracturing process.
